(19) United States
(12) Patent Application Publication
(10) Pub. No.: US 2009/0207613 A1
(43) Pub. Date: Aug. 20, 2009

(54) LIGHT SOURCE SYSTEM, LIGHT SOURCE DEVICE, AND METHOD OF CONTROLLING LIGHT SOURCE

(76) Inventors: Norimasa FURUKAWA, Tokyo (JP); Jun Shimizu, Miyagi (JP)

Correspondence Address: FROMMER LAWRENCE & HAUG LLP, 745 FIFTH AVENUE, NEW YORK, NY, 10151, US

(21) Appl. No.: 12/388,049

(22) Filed: Feb. 18, 2009

(30) Foreign Application Priority Data
Feb. 20, 2008 (JP) P2008-039129

(51) Int. Cl. F21S 6/00

(52) U.S. Cl. 362/257

(57) ABSTRACT

Light intensity may be locally increased in light intensity distribution without increasing number of light sources or drive current. A light source system includes a light source, and a diffusion unit varying diffusibility in incident light so that light intensity in a light intensity distribution in a plane, resulted from light emitted from the light source, is locally enhanced.

### CROSS REFERENCES TO RELATED APPLICATIONS

The present invention contains subject matter related to Japanese Patent Application JP 2008-039129 filed in the Japanese Patent Office on Feb. 20, 2008, the entire contents of which being incorporated herein by reference.

### BACKGROUND OF THE INVENTION

1. Field of the Invention

The present invention relates to a light source system, a light source device, and a method of controlling a light source, which may control luminance distribution of light from a light source.

2. Background Art

A light source using a rod-like fluorescent tube such as CCFL (Cold Cathode Fluorescent Lamp) has been known as, for example, a light source of a backlight of a liquid crystal display apparatus. Moreover, a backlight has been proposed, in which a rod-like ultraviolet lamp is used as a light source, and ultraviolet rays are converted into visible light for illumination light (refer to Japanese Unexamined Patent Application, Publication No. 2001-266605).

Recently, a backlight of a partial driving type is developed, in which a large number of LEDs (Light Emitting Diodes) are used as light sources, and a light-emitting surface is divided into a plurality of partial light emission regions, and each of the partial light emission regions is independently subjected to light-emitting control. In addition, a liquid crystal display apparatus using the backlight of the partial driving type is developed. In such a liquid crystal display apparatus, since luminance of a backlight may be partially varied depending on a picture to be displayed, a luminance reproduction range (dynamic range) beyond a limitative contrast ratio of liquid crystal display may be achieved. Specifically, a method is given as a first method, in which background light in a region for displaying a relatively dark image is locally reduced (turned off), thereby luminance of black is reduced, which is called local dimming as a commonly used name. As a second method, a method of local boosting is known in some academic society or the like, in which luminance of a partial light emission region is increased. The first method is practically used. However, the second method is not practically used yet, while a concept thereof is provided.

### SUMMARY OF THE INVENTION

In a previous backlight of a partial driving type, an amount of light emission of a light source itself is controlled, so that luminance is varied for each partial light emission region. Specifically, in case that a partial light emission region is to be darkened, drive current of a light source may be decreased. In case that the region is to be brightened, drive current of a light source may be increased. However, in case that the region is to be brightened, a brightening degree is limited due to a limit of efficiency of a light source, and a limit of a light source element. For example, in case that luminance two times higher than typical luminance is desired to be obtained, a current at least two times larger than a typical current may be necessarily flowed. That is, 50% of maximum light-quantity generation capability is constantly used during normal operation, resulting in extremely bad operation efficiency in an economical sense.

In case of designing a backlight that may be partially brightened, the number of light sources to be used may be necessarily increased, or input power of each of many light sources to be used may be necessarily increased up to approximately rated power. This is described with a specific example. For example, in TV use, there is a state where the whole screen is white, which is referred to as whole white display. In such a case, roughly about 600 [cd/m²] is typical brightness in the field. Further higher brightness is generally not necessary. Moreover, even in case that a light source is partially turned off, such higher brightness is not necessary. Therefore, it is most economically reasonable that number and a configuration, necessary for obtaining required brightness at approximately rated input power, are determined for working points of light sources to be used. However, in case that a screen is partially brightened, this is not true from the above circumstances. Theoretically, in case of brightening a screen, for example, a current at least two times larger than a typical current may be necessarily flowed in order to obtain luminance two times higher than typical luminance. However, for example, when a backlight is designed using a necessarily sufficient number of light sources to achieve required luminance during whole white display, further brightening of a backlight by flowing a further larger current may not be performed because of over-rating. That is, operation that a backlight is brightened while preventing input power from exceeding rated power inevitably leads to a design that the number of light sources is increased so as to output, for example, luminance of 1200 [cd/m²] being twice as high as 600 [cd/m²] with the rated current. This is the reason for the fact that 50% of maximum light-quantity generation capability is constantly used during normal operation, resulting in extremely bad operation efficiency in an economical sense. In this way, while a backlight can be conceptually partially brightened, the concept is actually hardly practiced due to the economical circumstances as an obstacle.

In view of foregoing, it is desirable to provide a light source system, a light source device, and a light source control method, which may locally increase light intensity in light intensity distribution without increasing number of light sources or drive current.

A light source system according to an embodiment of the invention includes a light source, and a diffusion unit varying diffusibility in incident light so that light intensity in a light intensity distribution in a plane, resulted from light emitted from the light source, is locally enhanced. The light source system also includes a display section modulating light emitted from the light source according to an inputted video signal.

A light source device according to an embodiment of the invention includes a light source, and a diffusion unit varying diffusibility in incident light so that light intensity in a light intensity distribution in a plane, resulted from light emitted from the light source, is locally enhanced.

A light source control method according to an embodiment of the invention includes varying diffusibility in incident light from a light source through use of a diffusion unit, thereby locally enhancing light intensity in a light intensity distribution in a plane, the light intensity distribution being resulted form light emitted from the light source.

In the light source system, the light source device, and the light source control method according to an embodiment of the invention, diffusibility in a diffusion unit varies so that light intensity in a light intensity distribution in a plane, resulted from light emitted from the light source, is locally enhanced.

In the light source system, the light source device, and the light source control method according to an embodiment of the invention, the diffusion unit is configured of, for example, a plurality of sheet-like optical members stacked, and at least one of the plurality of optical members is configured as a diffusibility variable element which varies the diffusibility in incident light. The diffusibility variable element may be configured, for example, through use of a liquid crystal element which switches between an incident light scattering mode and an incident light transmission mode. In this case, the liquid crystal element switches between the incident light scattering mode and the incident light transmission mode so that light intensity is locally enhanced.

According to the light source system, the light source device, and the light source control method according to an embodiment of the invention, a diffusion unit varies diffusibility in incident light so that light intensity in a light intensity distribution in a plane, resulted from light emitted from the light source, is locally enhanced. Therefore, a light intensity distribution is locally enhanced without increasing a number of light sources and drive current.

### BRIEF DESCRIPTION OF THE DRAWINGS

FIG. 1 shows a section view showing a configuration example of an illumination device as a light source system according to a first embodiment of the invention;

FIG. 2 shows a section view showing a configuration example of an illumination device according to a first comparative example;

FIG. 3 shows a section view showing a configuration example of an illumination device according to a second comparative example;

FIG. 4 shows an explanatory diagram of light intensity distribution in a previous illumination device;

FIG. 5 shows an explanatory diagram of light intensity distribution in the illumination device according to the first embodiment of the invention;

FIG. 6 shows a section view showing a first modification of the illumination device according to the first embodiment of the invention;

FIG. 7 shows a section view showing a second modification of the illumination device according to the first embodiment of the invention;

FIG. 8 shows a general block diagram showing an example of a display apparatus as a light source system using an illumination device according to a second embodiment of the invention;

FIG. 9 shows a diagram showing a configuration example of the illumination device according to the second embodiment of the invention;

FIG. 10 shows an explanatory diagram showing a superimposing relationship between luminance images in a light source section, a diffusion section, and a liquid crystal panel;

FIG. 11 shows a block diagram showing a circuit configuration of the display apparatus according to the second embodiment of the invention;

FIG. 12 shows an explanatory diagram showing a relationship of drive frequency between the light source section, the diffusion section, and the liquid crystal panel; and

FIGS. 13A to 13C show an explanatory diagrams of synthesis of luminance between the light source section and the diffusion section, respectively.

### DETAILED DESCRIPTION OF THE PREFERRED EMBODIMENTS

Hereinafter, preferred embodiments of the invention will be described in detail with reference to drawings.

### First Embodiment

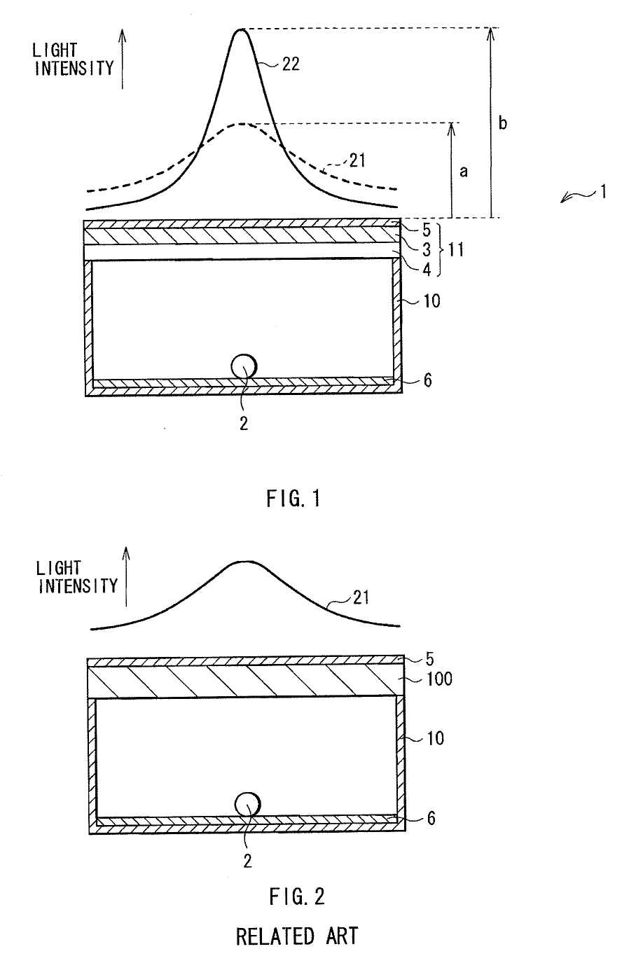

FIG. 1 shows a configuration example of a light source system according to a first embodiment of the invention together with an example of light intensity distribution in the system. In the embodiment, a configuration example of an illumination device 1 is described as a light source system. The illumination device 1 has a light source 2 disposed via a reflection seat 6 in the center of a bottom of a housing 10, and a diffusion section 11 disposed at an upper side (light emission side) of the housing 10. The light source 2 is configured by, for example, white LED. A plurality of light sources 2 may be provided.

The diffusion section 11 corresponds to a specific example of the “diffusion unit” of the invention. The illumination device 1 corresponds to a specific example of the “light source device” of the invention.

The diffusion section 11 is configured by stacking a plurality of sheet-like optical members. Specifically, a diffusibility variable element 4 configured to be variable in diffusibility of incident light, a diffuser plate 3 being fixed in diffusibility, and an optical sheet 5 for increasing total luminance are stacked in this order from the light source 2 side as optical members.

The diffusibility variable element 4 is configured by a liquid crystal element that may electrically change in operation state to incident light between a scattering mode and a transmission mode, for example, by a polymer dispersed liquid crystal (PDLC). The polymer dispersed liquid crystal is a liquid crystal element using a phenomenon that a liquid crystal has a structure separated in phase in a polymer matrix, and is structured such that a polymer dispersed with many liquid crystal droplets is sandwiched by transparent conductive films. In the polymer dispersed liquid crystal, in case that an electric field is not applied, since orientation vectors of the dispersed liquid crystal droplets are oriented in directions different from one another, light is scattered at each interface, thereby an opaque white state (scattering mode) is formed. Conversely, an electric field is applied, thereby refractivity of a polymer becomes approximately equal to that of a liquid crystal, so that a transparent state (transmission mode) is formed. The previous liquid crystal element has a difficulty that since light is modulated using a mechanism including a polarizing plate and an orientation plate, quantity of incident light is decreased due to such a structure. However, in the polymer dispersed liquid crystal, since the polarizing plate and the orientation plate are not used, loss of light quantity is small.

In the illumination device 1 of the embodiment, diffusibility is varied by the diffusibility variable element 4 of the diffusion section 11, thereby light intensity in a plane of light emitted from the light source 2 may be locally increased or decreased. That is, a state of the diffusibility variable element 4 is changed from a scattering mode to a transmission mode, thereby first light intensity distribution 21 being normal light intensity distribution may be changed into second light intensity distribution 22, in which light intensity at the center is locally increased from a to b, without increasing number of the light sources 2 or drive current.

Here, an advantage obtained by change of light intensity distribution in the illumination device 1 is described while being compared to a structure of a previous illumination device.

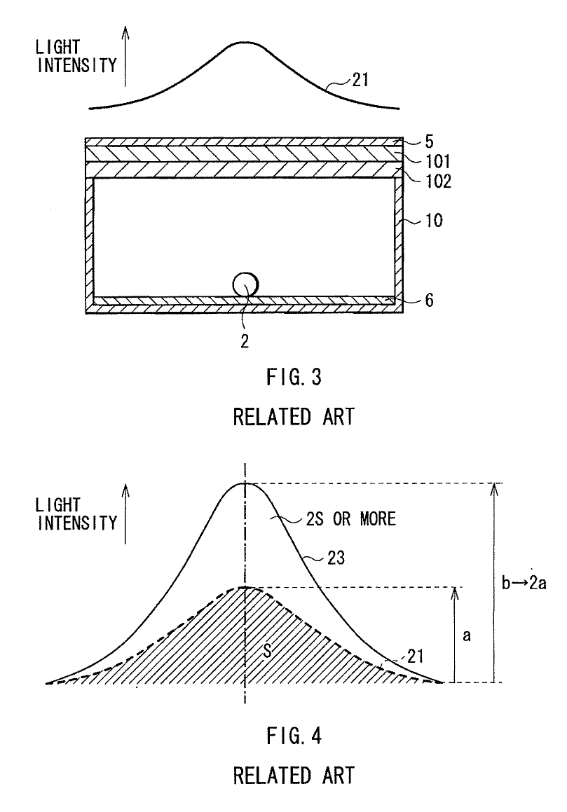

FIG. 2 shows a structure of a first comparative example with respect to the illumination device 1. An illumination device according to the first comparative example has a single diffuser plate 100 having fixed diffusibility in place of the diffuser plate 3 and the diffusibility variable element 4 in the illumination device 1 according to the embodiment. FIG. 3 shows a structure of a second comparative example. An illumination device according to the second comparative example has two diffuser plates 101 and 102, each having fixed diffusibility, in place of the diffuser plate 3 and the diffusibility variable element 4 in the embodiment.

In the illumination device according to each of the comparative examples of FIGS. 2 and 3, to increase light intensity “a” at the center twice, current to be flowed into the light source 2 may be necessarily increased at least twice (power may be necessarily increased at least twice). In this case, change in light intensity distribution is, for example, as shown in FIG. 4. Current is flowed at least twice, thereby first light intensity distribution 21 having light intensity “a” at the center is changed into second light intensity distribution 23 having light intensity “b” at the center. In this case, the second light intensity distribution 23 formed after increasing current has a broadening profile of light intensity distribution expanded in a similar shape to the first light intensity distribution 21. In case that the light intensity “a” at the center is increased at least twice, area S indicating light intensity distribution is increased at least twice (increased to at least 2S).

On the other hand, in the illumination device 1 according to the embodiment, change in light intensity distribution is, for example, as shown in FIG. 5. In the embodiment, even if amount of light emission of the light source 2 itself is not changed (current is constant), a state of the diffusibility variable element 4 is changed from a scattering mode to a transmission mode, thereby the light intensity “a” at the center may be increased to “b”. In the second light intensity distribution 22 formed after changing diffusibility, a broadening profile of light intensity distribution is not similar to that of the first light intensity distribution 21 before changing diffusibility, and (if loss of light quantity associated with such change by the diffusibility variable element 4 is zero), area S indicating light intensity distribution is not changed. In this case, light diffused in a peripheral region in the first light intensity distribution 21 before changing diffusibility is distributed to the center as shown by a symbol 41, thereby light intensity at the center is locally increased.

As described hereinbefore, according to the illumination device 1 of the embodiment, a diffusion unit configured to be variable in diffusibility of incident light is provided, so that diffusibility is varied, thereby light intensity in a plane of light emitted from the light source 2 is locally increased. Therefore, light intensity may be locally increased in light intensity distribution without increasing number of light sources 2 or drive current.

### Modifications of the First Embodiment

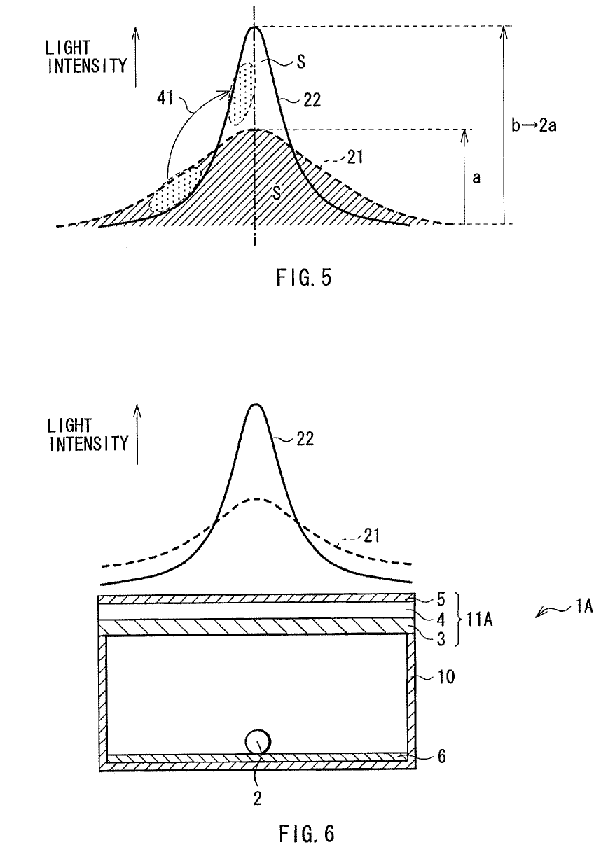

FIG. 6 shows a first modification of the illumination device 1 (FIG. 1) according to the embodiment.

An illumination device 1A according to the first modification is changed in stacking order of a stacked structure in the diffusion section 11 of the illumination device 1 shown in FIG. 1. In a diffusion section 11A of the illumination device 1A, a diffuser plate 3 being fixed in diffusibility, a diffusibility variable element 4, and an optical sheet 5 are stacked in this order from a light source 2 side as optical members. The illumination device 1A is different from the illumination device 1 shown in FIG. 1 only in stacking order of the stacked structure of the optical members in the diffusion section 11, and optical operation and effects of the device as a whole are the same as those of the illumination device 1.

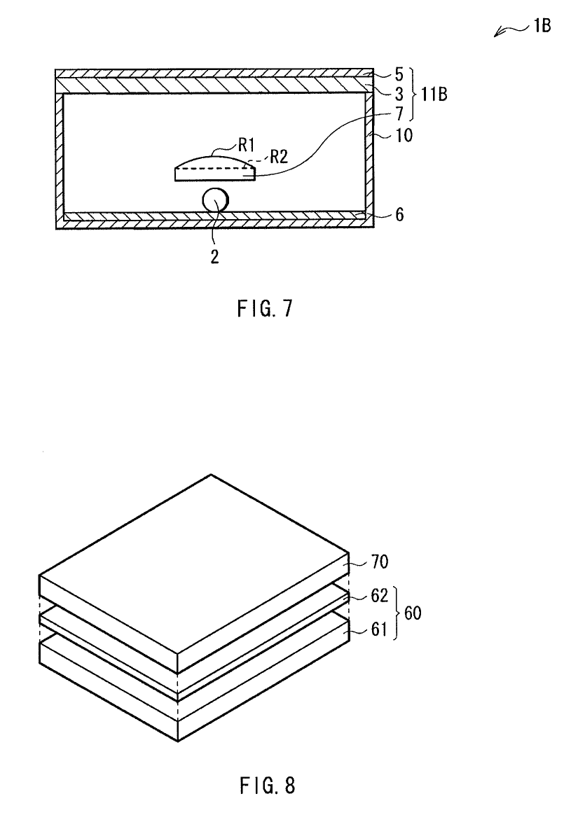

FIG. 7 shows a second modification of the illumination device 1 according to the embodiment.

The illumination device 1 shown in FIG. 1 is structured to have the diffusibility variable element 4 using, for example, a polymer dispersed liquid crystal in the diffusion section 11. However, an illumination device 1B according to the second modification includes a diffusion section 11B having a liquid lens 7 in place of the diffusibility variable element 4. The liquid lens 7 is disposed, for example, on a light source 2 side away from the diffuser plate 3 and the optical sheet 5. In the liquid lens 7, the radius of curvature of a lens surface is electrically variable, and for example, the radius of curvature is changed from R2 to R1 so as to increase convex-lensed power, thereby a light condensing effect to the center may be changed to be relatively strong. Even in the case, light intensity may be locally increased in light intensity distribution without increasing number of light sources 2 or drive current.

In addition, while omitted to be shown, a structure where at least two diffusibility-variable elements 4 are stacked may be used as a diffusion unit of the embodiment.

### Second Embodiment

Next, a second embodiment of the invention is described. Substantially the same components as in the first embodiment are marked with the same symbols, and description of them is appropriately omitted.

The embodiment relates to a configuration example in case that the illumination device 1 according to the first embodiment is applied to a backlight of a display apparatus. FIG. 8 shows an example of a display apparatus as a light source system according to the embodiment. The display apparatus is a transmission liquid crystal display apparatus, and includes a backlight 60 and a liquid crystal panel 70. The liquid crystal panel 70 is a display section that uses illumination light from the backlight 60 to display a picture according to an input video signal Vin, and has a function of modulating the illumination light based on the input video signal Vin. The backlight 60 may include a diffusion section 62 in addition to a light source section 61.

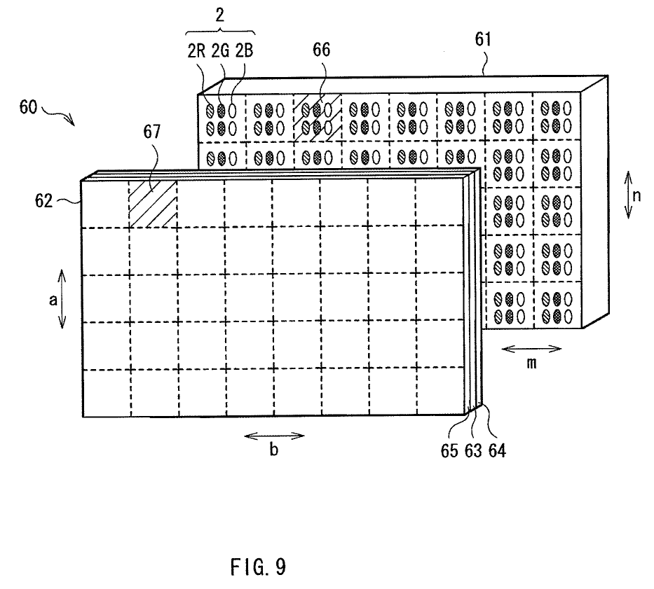

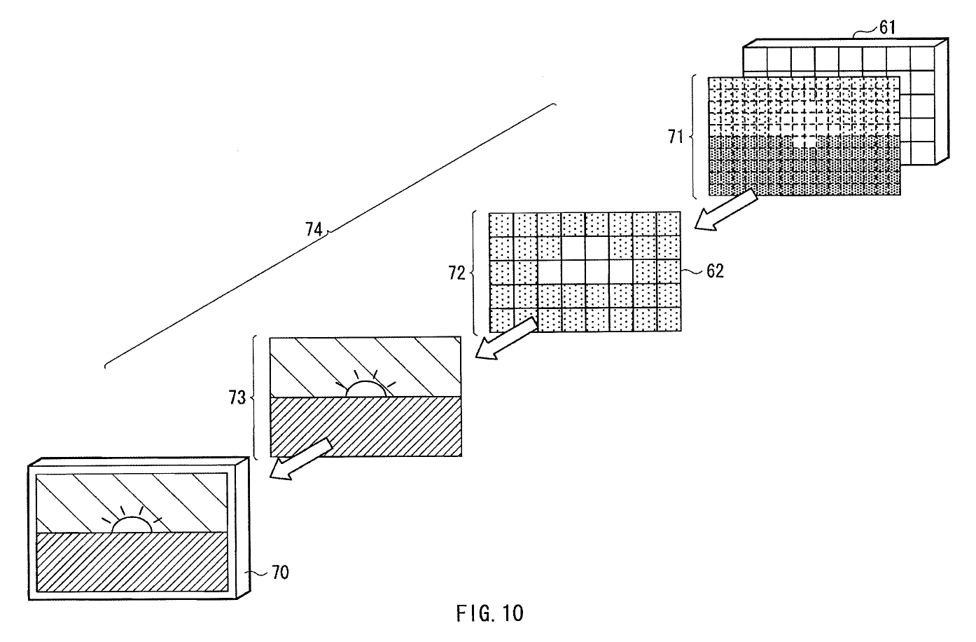

FIG. 9 shows a configuration example of the backlight 60. The backlight 60 is configured by an LED backlight of a partial driving type. The light source section 61 has a plurality of partial light emission regions 66 formed by two-dimensionally arranging a plurality of light sources 2. Thus, in the light source section 61, a light emitting area is divided into n(row)*m(column)=K (n or m is an integer of at least 2) in an in-plane direction. The light source section 61 is designed to be able to individually perform light emitting control for each partial light emission region 66 according to the input video signal Vin. The light source 2 is configured by a combination of red LED 2R emitting red light, green LED 2G emitting green light, and blue LED 2B emitting blue light, and emits white light through additive color mixture of respective color light. Each partial light emission region 66 has at least one light source 2 disposed therein.

A diffusion section 62 corresponds to a specific example of the “diffusion unit” of the invention, and essentially has the same function as that of the diffusion section 11 of the first embodiment. That is, in the diffusion section 62, a diffusibility variable element 64 configured to be variable in diffusibility of incident light, a diffuser plate 63 being fixed in diffusibility, and an optical sheet 65 for increasing total luminance are stacked in this order from a light source 2 side as optical members. The diffusibility variable element 64 is configured by a polymer dispersed liquid crystal or the like, and may electrically change in operation state to incident light between a scattering mode and a transmission mode for each of a plurality of partial diffusion areas 67 set in a two-dimensional matrix. Thus, in the diffusion section 62, a diffusion area is divided into a(row)*b(column)=c (a or b is an integer of at least 2) in an in-plane direction. Thus, the diffusion section 62 is configured to be variable in diffusibility for each of the plurality of partial diffusion areas 67, and is designed to vary diffusibility so that light intensity in a plane of light emitted from the light source section 61 may be locally increased for each of the plurality of partial diffusion areas 67 according to the input video signal Vin.

The number of surface segmentation of each of the light source section 61 and the diffusion section 62 is set sufficiently small compared with the number of pixels of the liquid crystal panel 70 (for example, while the number of pixels of the liquid crystal panel 70 is several million, the number of surface segmentation of each of the light source section 61 and the diffusion section 62 is about several dozen to several hundred). In other word, size of each partial light emission region 66 of the light source section 61 and size of each partial diffusion region 67 of the diffusion section 62 are set sufficiently large compared with size of each pixel of the liquid crystal panel 70, respectively. In FIG. 9, while the number of surface segmentation of the light source section 61 is equal to that of the diffusion section 62, the number of surface segmentation may be different between the sections. That is, size of the partial light emission region 66 of the light source section 61 may be different from size of the partial diffusion region 67 of the diffusion section 62. In such a case, either region size may be larger. That is, when the number of segmentation of the light source section 61 is assumed to be n(row)*m(column)=K, and the number of surface segmentation of the diffusion section 62 is assumed to be a(row)*b(column)=c, a configuration where K=c is established is not limitedly used, and a configuration where K>c or K<c is established may be used.

In the display apparatus, illumination light from the light source section 61 is illuminated from a back side of the liquid crystal panel 70 via the diffusion section 62. In the liquid crystal panel 70, illumination light is modulated according to the input video signal Vin, so that a picture is displayed. Luminance of a picture to be finally displayed is conceptually given by superimposing and synthesizing luminance on a light-emitting surface of the light source section 61, luminance of a diffusion surface of the diffusion section 62, and luminance of a display surface of the liquid crystal panel 70.

FIG. 10 schematically shows a luminance image in each of the light source section 61, the diffusion section 62, and the liquid crystal panel 70. In the display apparatus, as shown in the figure, a synthesized image 74 is given as the picture to be finally displayed, the synthesized image being made by physically superimposing (multiplicatively synthesizing) a display surface image 71 in the light source section 61, a diffusion surface image 72 in the diffusion section 62, and a panel surface image 73 in the liquid crystal panel 70 alone.

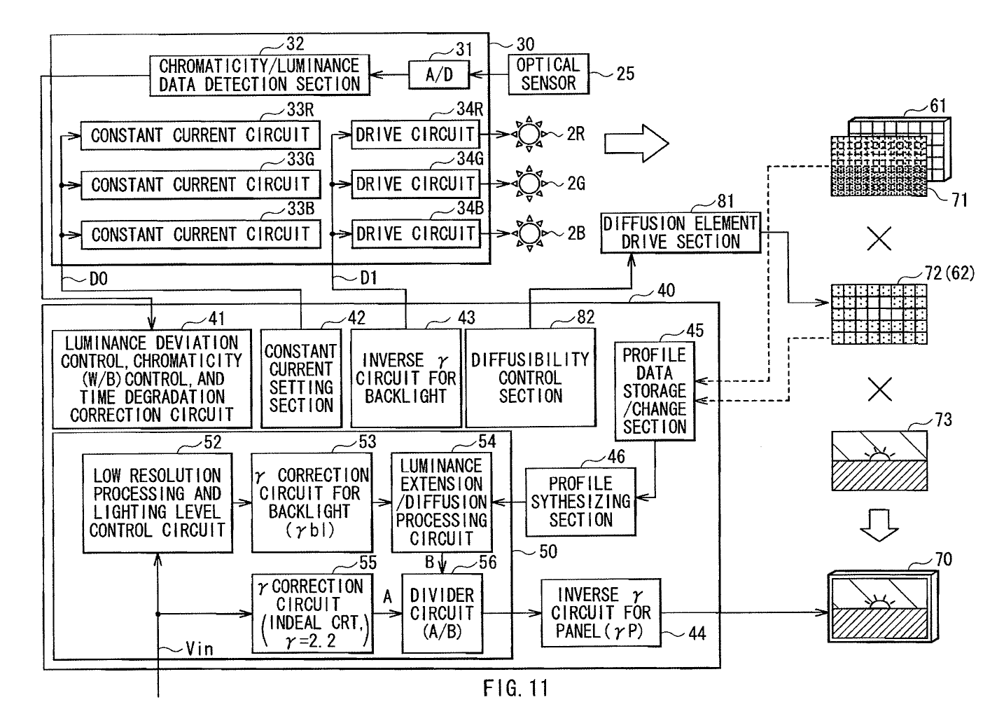

FIG. 11 shows a circuit configuration example of a control system and a drive system of the display apparatus.

The display apparatus includes an optical sensor 25 that detects amount of light emission (luminance) of the light sources 2 (LED 2R, 2G and 2B) of the light source section 61, an LED drive section 30 that drives (the light sources 2 of) the light source section 61, a diffusion element drive section 81 that drives (the diffusibility variable element 64 of) the diffusion section 62, and a control section 40 that performs signal processing of the input video signal Vin, and controls each of the sections.

The LED drive section 30 controls light emission of respective LEDs 2R, 2G and 2B according to PWM control by using a pulsed PWM (Pulse Width Modulation) signal from the control section 40 as an LED drive signal D1. The LED drive section 30 includes an A/D conversion circuit 31 that converts an analog detection signal from the optical sensor 25 into a digital signal, and a chromaticity/luminance data detection section 32 that detects chromaticity/luminance data of the light sources 2 based on the detection signal from the optical sensor 25, and outputs the detected data. The chromaticity/luminance data given by the chromaticity/luminance data detection section 32 is outputted to the control section 40, and used for feedback control of the respective LEDs 2R, 2G and 2B. Furthermore, the LED drive section 30 includes constant current circuits 33R, 33G and 33B that supply constant current to the LED 2R, 2G and 2B according to a constant current setting signal D0 from the control section 40 respectively, and drive circuits 34R, 34G and 34B that drive the LEDs 2R, 2G and 2B, respectively, according to an LED drive signal D1 from the control section 40 respectively.

The control section 40 includes a circuit 41 that performs luminance deviation control, chromaticity (white balance (W/B)) control, and time degradation correction of the light source 2 based on the chromaticity/luminance data given by the chromaticity/luminance data detection section 32, a constant current setting section 42 that outputs the constant current setting signal D0 to each of the constant current circuits 33R, 33G and 33B of the LED drive section 30, an inverse γ (gamma) circuit 43 for a backlight that output the LED drive signal D1 to each of the drive circuits 34R, 34G and 34B of the LED drive section 30, and a diffusibility control section 82 that controls the diffusion element drive section 81.

Furthermore, the control section 40 includes a profile-data storage/change section 45 that stores two kinds of profile data (first and second light intensity distribution data) described later, and changes between the first and second light intensity distribution data according to the input video signal Vin, and outputs the changed data; and a profile synthesizing section 46 that obtains synthesized data by synthesizing the first and second light intensity distribution data, the respective data being stored in the profile-data storage/change section 45 according to the input video signal Vin. Furthermore, the control section 40 includes an image processing section 50 that performs luminance correction to the input video signal Vin based on the synthesized data from the profile synthesizing section 46, and thus generates an appropriate picture to be displayed on the liquid crystal panel 70, and an inverse γ circuit 44 for a panel that drives the liquid crystal panel 70 with an appropriate gamma value γP according to an output signal from the image processing section 50.

The profile-data storage/change section 45 corresponds to a specific example of the “storage unit” of the invention. The profile synthesizing section 46 corresponds to a specific example of the “synthesizing unit” of the invention. The image processing section 50 and the inverse y circuit 44 for a panel collectively correspond to a specific example of the “correction unit” of the invention.

The image processing section 50 includes a circuit 52 that performs low resolution processing corresponding to the number of surface segmentation of the backlight 60 (the light source section 61 and the diffusion section 62) to the input video signal Vin, and performs lighting control of the backlight 60; a γ correction circuit 53 for a backlight that performs gamma correction to the input video signal Vin subjected to the low resolution processing with an appropriate gamma value γb1 of the backlight 60; and a circuit 54 that performs extension/diffusion processing of luminance to a video signal subjected to the gamma correction based on the synthesized data from the profile synthesizing section 46. Furthermore, the image processing section 50 includes a γ correction circuit 55 that performs gamma correction to the input video signal Vin with, for example, a gamma value γ=2.2 of ideal CRT (Cathode-Ray Tube); and a divider circuit 56 that outputs a signal obtained by dividing a video signal A subjected to gamma correction by the γ correction circuit 55 by the video signal B corrected by the circuit 54 based on synthesized data. An output signal from the divider circuit 56 is inputted into the inverse y circuit 44 for a panel.

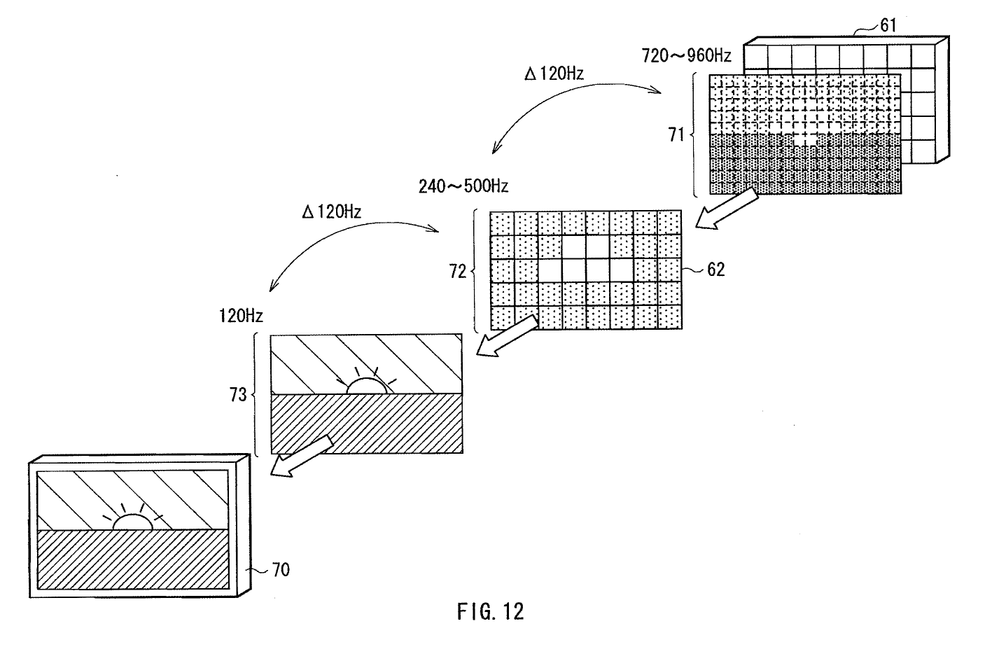

FIG. 12 shows a relationship of drive frequency between the light source section 61, the diffusion section 62, and the liquid crystal panel 70 in the display apparatus. In the display apparatus, a frame rewriting drive frequency for picture display in the liquid crystal panel 70, a drive frequency of the light sources 2 for controlling light emission in the light source section 61, and a drive frequency for varying diffusibility in the diffusion section 62 are different from one another, and the three drive frequencies are set to such frequencies that a visual beat (flicker) is not induced between the frequencies respectively. For example, when the frame rewriting drive frequency of the liquid crystal panel 70 is assumed to be 120 Hz, the diffusion section 62 is preferably set with a drive frequency of integral multiple of Δ120 Hz (for example, 240 Hz). In addition, the light source section 61 is preferably set with a drive frequency of further integral multiple of Δ120 Hz from the drive frequency of the diffusion section 62 (for example, 720 Hz). This may prevent phase shift in operation of each of the light source section 61 and the diffusion section 62 with respect to start timing of each frame in the liquid crystal panel 70.

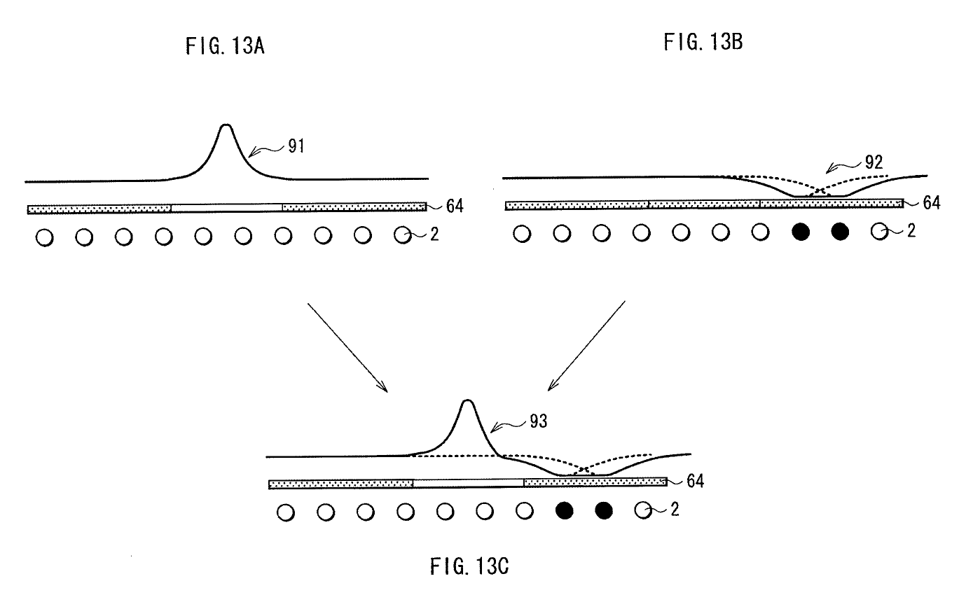

Next, profile data stored by the profile data storage/change section 45 are described with reference to FIGS. 13A to 13C. In the embodiment, the term “profile data” refers to data of a partially brightening degree (blurring degree of luminance, or light intensity distribution) when the backlight 60 is partially driven. In the embodiment, the backlight 60 has the light source section 61 and the diffusion section 62, and the sections are independently driven. Therefore, profile data are beforehand obtained in the respective sections, and the respective data are synthesized and thus the total profile data are calculated. That is, in the light source section 61, when only a part of the plurality of partial light emission regions 66 are turned on, a brightening degree (light intensity distribution) of the relevant part of the light emitting surface is beforehand obtained as first light intensity distribution data (first profile data). In addition, in the diffusion section 62, when a part of the plurality of partial diffusion regions 67 are changed into a transmission mode, a brightening degree (light intensity distribution) of the relevant part of the diffusion surface is beforehand obtained as second light intensity distribution data (second profile data). Then, the first and second data are synthesized to calculate synthesized light intensity distribution data (synthesized profile data).

FIG. 13A shows a specific example of the second light intensity distribution data. As shown in FIG. 13A, the profile data storage/change section 45 makes the plurality of partial light emission regions 66 of the light source section 61 into a uniform light-emitting state (turns on all the light sources 2), and stores data as the second light intensity distribution data, the data showing change in light intensity distribution 91 when diffusibility in part of the plurality of partial diffusion regions 67 is changed (when the diffusibility variable element 64 is partially changed into a transmission mode) in the diffusion section 62.

FIG. 13B shows a specific example of the first light intensity distribution data. The profile data storage/change section 45 makes the plurality of partial diffusion regions 67 of the diffusion section 62 into a uniform diffusibility state (the diffusibility variable element 64 is wholly changed into a scattering mode), and stores data as the first light intensity distribution data, the data showing change in light intensity distribution 92 when luminance of the light sources 2 in part of the plurality of partial light emission regions 66 is changed (when the light sources 2 are turned off) in the light source section 61.

FIG. 13C shows a concept of synthesized data generated by the profile synthesizing section 46. The first light intensity distribution data and the second light intensity distribution data are synthesized, thereby in case that luminance of the light sources 2 in part of the plurality of partial light emission regions 66 is changed in the light source section 61, and diffusibility in part of the plurality of partial diffusion regions 67 is changed in the diffusion section 62, light intensity distribution may be obtained. FIG. 13C shows synthesized light intensity distribution 93 (light intensity distribution of the backlight 60 as a whole) obtained by synthesizing the first light intensity distribution 91 shown in FIG. 13A and the second light intensity distribution 92 shown in FIG. 13B.

The image processing section 50 performs appropriate luminance correction to the input video signal Vi by using such synthesized light intensity distribution data. Thus, the liquid crystal panel 70 may display an appropriate picture.

According to the display apparatus of the embodiment, the backlight 60 has the diffusion unit configured to be variable in diffusibility of incident light, and the diffusibility is varied, thereby light intensity in a plane of light emitted from the light sources 2 is locally increased. Therefore, light intensity may be locally increased in light intensity distribution without increasing number of light sources 2 or drive current. Moreover, since a video signal is corrected so as to be corresponding to light intensity distribution of the backlight 60 so that the liquid crystal panel 70 is appropriately driven, excellent picture display may be performed while extending a dynamic range.

### Other Embodiments

The invention is not limited to the embodiments, and various other modifications can be made.

For example, while a liquid crystal display apparatus was shown as an example of a display apparatus in the second embodiment, the illumination device of the invention may be used for a display apparatus other than the liquid crystal display apparatus. Moreover, the illumination device of the invention may be used for applications other than a backlight of a display apparatus.

It should be understood by those skilled in the art that various modifications, combinations, sub-combinations and alterations may occur depending on design requirements and other factors insofar as they are within the scope of the appended claims or the equivalent thereof.

What is claimed is:

1. A light source system comprising:
a light source, and
a diffusion unit varying diffusibility in incident light so that light intensity in a light intensity distribution in a plane, resulted from light emitted from the light source, is locally enhanced.

2. The light source system according to claim 1, wherein
the diffusion unit is configured of a plurality of sheet-like optical members stacked, and
at least one of the plurality of optical members is configured as a diffusibility variable element which varies the diffusibility in incident light.

3. The light source system according to claim 2, wherein the diffusibility variable element is configured through use of a liquid crystal element which switches between an incident light scattering mode and an incident light transmission mode.

4. The light source system according to claim 1, comprising a plurality of light sources arranged in a two-dimensional manner to configure a light source section, wherein
the light source section includes a plurality of partial light emission regions corresponding to the plurality of light sources, respectively, light emission in each of the partial light emission regions being controlled independently, and
the diffusion unit is configured to include a plurality of partial diffusion regions corresponding to the plurality of partial light emission regions, respectively, diffusibility in each of the partial diffusion regions being controlled independently, and light intensity in a light intensity distribution in a plane, resulted from light emitted from the light source section, is locally enhanced, by partial diffusion region, through varying the diffusibility in corresponding partial diffusion region.

5. The light source system according to claim 4, further comprising a display section modulating light emitted from the light source according to an inputted video signal.

6. The light source system according to claim 5, further comprising:
a storage unit storing first light intensity distribution data and second light intensity distribution data, the first light intensity distribution data representing change in light intensity distribution corresponding to change in luminance of light sources in part of the plurality of partial light emission regions in the light source section, the second light intensity distribution data representing change in light intensity distribution corresponding to change in diffusibility in part of the plurality of partial diffusion regions in the diffusion unit,
a synthesis unit synthesizing the first and the second light intensity distribution data stored in the storage unit according to the inputted video signal, thereby obtaining synthesized data, and
a correction unit correcting luminance in the input video signal based on the synthesized data, thereby generating a picture to be displayed on the display section.

7. The light source system according to claim 6, wherein
the first light intensity distribution data represents change in light intensity distribution corresponding to change in luminance of the light sources in part of the plurality of partial light emission regions in the light source section, under condition that all of the partial diffusion regions of the diffusion unit are maintained into a uniform diffusibility state, and
the second light intensity distribution data represents change in light intensity distribution corresponding to change in diffusibility in part of the plurality of partial diffusion regions in the diffusion unit, under condition that all of the partial light-emission regions of the light source section are maintained into a uniform light emission state.

8. The light source system according to claim 5, using first to third drive frequencies, the first drive frequency being a frame rewriting drive frequency for picture display in the display unit, the second drive frequency being a drive frequency of the light sources for controlling light emission in the light source section, the third drive frequency being a drive frequency for changing diffusibility in the diffusion unit,
wherein the first to third drive frequencies are different from one another, and are set into such frequencies that a visual beat is suppressed.

9. A light source device comprising:
a light source, and
a diffusion unit varying diffusibility in incident light so that light intensity in a light intensity distribution in a plane, resulted from light emitted from the light source, is locally enhanced.

10. A light source control method comprising:
varying diffusibility in incident light from a light source through use of a diffusion unit,
thereby locally enhancing light intensity in a light intensity distribution in a plane, the light intensity distribution being resulted form light emitted from the light source.
